(19) United States
(12) Patent Application Publication
(10) Pub. No.: US 2021/0355244 A1
(43) Pub. Date: Nov. 18, 2021

(54) MODIFIED CELLULOSE NANOFIBER, SINGLE-LAYER LAMINATE INCLUDING THE SAME, AND METHOD FOR MANUFACTURING MODIFIED CELLULOSE NANOFIBER

(71) Applicant: NATIONAL TAIWAN UNIVERSITY OF SCIENCE AND TECHNOLOGY, Taipei City (TW)

(72) Inventors: Masaki Ujihara, Taipei City (TW); Toyoko Imae, Taipei City (TW)

(21) Appl. No.: 16/875,666

(22) Filed: May 15, 2020

(51) Int. Cl. C08B 15/02; C08L 1/04

(52) U.S. Cl. CPC C08B 15/02; C08L 1/04

(57) ABSTRACT

A modified cellulose nanofiber, a single-layer laminate including the same, and a method for manufacturing the modified cellulose nanofiber are disclosed. The modified cellulose nanofiber includes a TEMPO-oxidized cellulose nanofiber that is modified by amine compounds with long alkyl chains to have alkylamine groups and carboxyl groups, wherein the alkylamine groups is 20 to 90% of the carboxyl groups.

### TECHNICAL FIELD

The present disclosure relates to a modified cellulose nanofiber and a method for manufacturing the same, more particularly, to a modified cellulose nanofiber and a method for manufacturing the same that are highly transparent, oil and water repellent, and free of fluorinated compound.

### BACKGROUND

Conventionally, oil-repellent and anti-fingerprint technologies have depended on perfluorinated compounds to achieve the objectives. However, the perfluoride compounds are expensive and non-biodegradable, and due to the high cost of perfluorinated compounds, the conventional films for oil-repellency and anti-finger print applications are used as thin coating layers on the other material.

In the attempts of avoiding the issues and demerits of perfluorinated compounds, short-chain perfluorinated compounds and non-fluoride compounds have been used as alternatives. Nevertheless, short-chain perfluorinated compounds still possess properties that raise environmental concerns, and oil-repellency is difficult to accomplish with the non-fluoride compounds.

### SUMMARY

To solve the aforementioned issues, the present disclosure provides a modified cellulose nanofiber that includes cellulose nanofiber prepared by TEMPO-oxidation and modified by amine compounds with long alkyl chains by amidation reaction with moderate binding ratio. The modified cellulose nanofiber is a biodegradable and eco-friendly material, and can be used as both a self-standing film and a coating layer on various substrates.

An object of the present disclosure is to provide a non-fluoride oil-repellant film consists of the modified cellulose nanofiber, wherein the film has sufficient mechanical properties and high transparency. Since the film is colorless, it does not obstruct designs underneath the film/coating, and therefore is applicable to optical devices like mobile phones. Moreover, the film/coating exhibits hydrophobicity and oil-repellency, and therefore can be used for the self-cleaning and anti-fingerprint films and coating.

An object of the present disclosure is to provide a method for manufacturing modified cellulose nanofiber that uses non-fluorides and chemically modifies the cellulose nanofiber by ordinary amine compounds with long alkyl chains and by amidation reaction. Since the cellulose nanofibers and non-fluoride compounds are obtained from cellulose pulp, the disadvantages of conventional films that used fluorinated compounds for oil-repellent and anti-fingerprint applications can be avoided.

An object of the present disclosure is to provide a modified cellulose nanofiber that includes a TEMPO-oxidized cellulose nanofiber amidated with amine compounds with long alkyl chains and having alkylamine groups and carboxyl groups, wherein the alkylamine groups is 20 to 90% of the carboxyl groups.

Optionally, the modified cellulose nanofiber further includes the following chemical structure:

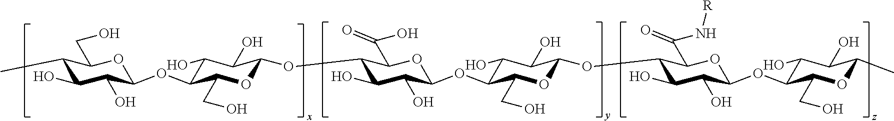

wherein x=0.5 to 0.83, y+z=0.17 to 0.5, z=0.2 to 0.9 of y+z, and x+y+z=1. R represents an alkyl group.

Optionally, a molality of the alkylamine groups in the chemical structure is 0.1 to 1.0 mmol/g.

Optionally, the alkylamine groups is preferably 30 to 70% of the carboxyl groups.

Optionally, the amine compounds with long alkyl chains are dodecylamine, tetradecylamine, hexadecylamine, octadecylamine or oleylamine and include 12 to 18 carbon atoms.

Optionally, the modified cellulose nanofiber is free of fluorinated compound.

Another object of the present disclosure is to provide a single-layer laminate that includes the modified cellulose nanofiber as defined above, wherein the laminate exhibits hydrophobicity and oil-repellency characteristics.

Optionally, the single-layer laminate is transparent.

Optionally, the single-layer laminate is a coating formed by spraying the modified cellulose nanofiber on an article.

Optionally, the single-layer laminate is a self-standing film.

Optionally, a thickness of the self-standing film is equal to or greater than 10 μm.

Optionally, the single-layer laminate is free of fluorinated compound.

Another object of the present disclosure is to provide a method for manufacturing modified cellulose nanofiber, and the method includes the steps of: providing cellulose; oxidizing the cellulose by TEMPO-oxidation reaction; dispersing the oxidized cellulose in a solvent to form a solvent mixture, wherein the solvent is water or organic solvent; and adding amine compounds with long alkyl chains to the solvent mixture and mixing the amine compounds and the oxidized cellulose homogeneously to achieve amidation reaction with a binding ratio of 20 to 90% carboxyl groups in the modified cellulose nanofiber.

Optionally, the method for manufacturing modified cellulose nanofiber further includes the step of recovering the modified cellulose nanofiber by filtration or centrifugation.

Optionally, the method for manufacturing modified cellulose nanofiber further includes the step of drying the modified cellulose nanofiber to form a laminate film.

Optionally, the method for manufacturing modified cellulose nanofiber further includes the step of performing nano-fibrillization to the oxidized cellulose.

Optionally, the method for manufacturing modified cellulose nanofiber further includes the step of dissolving a condensation reagent in the solvent mixture to activate the carboxyl groups in the oxidized cellulose.

Optionally, the method for manufacturing modified cellulose nanofiber is substantially free of fluorinated compound.

Optionally, a molality of the carboxyl groups in the oxidized cellulose before amidation reaction is 0.5 to 1.5 mmol/g.

In short, the modified cellulose nanofiber, the single-layer laminate including the same, and the method for manufacturing modified cellulose nanofiber of the present disclosure replace perfluorinated compounds in conventional anti-fingerprint coating with cellulose nanofiber and non-fluorinated compounds, which are mechanically strong and therefore the laminate can be thick enough to be self-standing. The modified cellulose nanofiber decreases light scattering and thus the laminate is highly transparent. Therefore, the laminate can be used for oil-repellent and anti-fingerprint applications by itself.

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1 is a flowchart of a method for manufacturing modified cellulose nanofiber according to an embodiment of the present disclosure.

FIG. 2 illustrates the chemical structure of TEMPO-oxidized cellulose nanofiber according to an embodiment of the present disclosure.

FIG. 3 illustrates the chemical structure of modified cellulose nanofiber according to an embodiment of the present disclosure.

FIG. 4 illustrates photo images of test results of a single-layer laminate of the present disclosure and test results of a conventional TEMPO-oxidized cellulose nanofiber film.

FIG. 5 illustrates photo images of test results of a glass plate coated with a single-layer laminate of the present disclosure and test results of a conventional glass plate.

### DETAILED DESCRIPTION OF THE PREFERRED EMBODIMENTS

The present disclosure provides a modified cellulose nanofiber, a single-layer laminate including the same, and a method for manufacturing the modified cellulose nanofiber. The modified cellulose nanofiber is a TEMPO-oxidized cellulose nanofiber that has been modified by long alkyl chains from amine compounds by amidation reaction, wherein the alkylamine groups is 20 to 90% of the carboxyl groups in the modified cellulose nanofiber. The modified cellulose nanofiber is formed by easy chemical reactions and uses non-fluorinated compounds that decompose easily, and therefore the material is eco-friendly and the production cost is low. The modified cellulose nanofiber can be used to make a single-layer laminate that possesses strong mechanical strength and is scratch-resistant and highly transparent, wherein the laminate can be a coating or a self-standing film. In addition, the laminate exhibits hydrophobicity and oil-repellency characteristics, and thus can be used as self-cleaning and anti-fingerprint films and coatings.

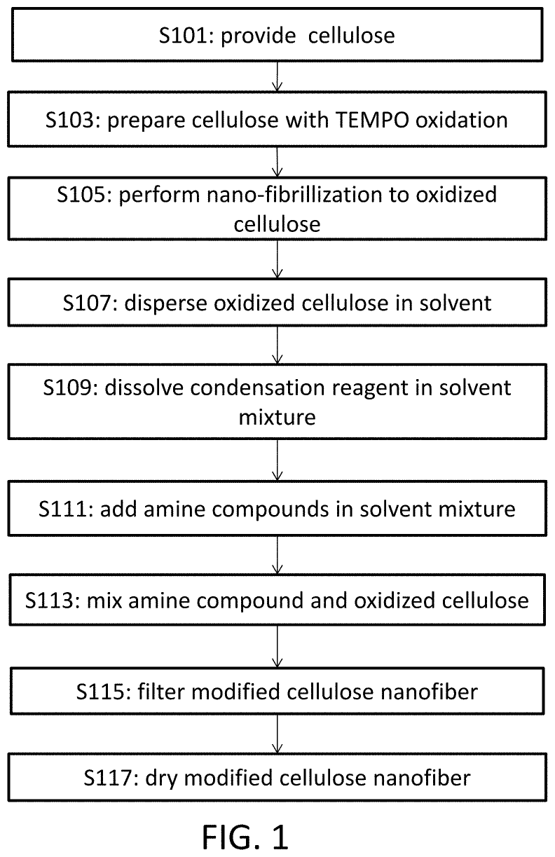

FIG. 1 is a flowchart of a method for manufacturing modified cellulose nanofiber according to an embodiment of the present disclosure. The manufacturing method begins by providing a cellulose fiber in step S101, wherein the cellulose fiber is obtained from cellulose pulp. The cellulose fiber can be any type of fiber, for example but not limited to, pulp fiber. In one embodiment, the cellulose pulp is a never-dried pulp.

In step S103, the cellulose fiber is washed or oxidized by TEMPO ((2,2,6,6-tetramethylpiperidin-1-yl)oxyl or (2,2,6,6-tetramethylpiperidin-1-yl)oxidanyl). The TEMPO-oxidation reaction is a known technology and therefore is not described herein. In one embodiment, the cellulose fiber is oxidized by TEMPO-NaBr-NaClO system. After the TEMPO-oxidation reaction, TEMPO-oxidized cellulose fiber is formed.

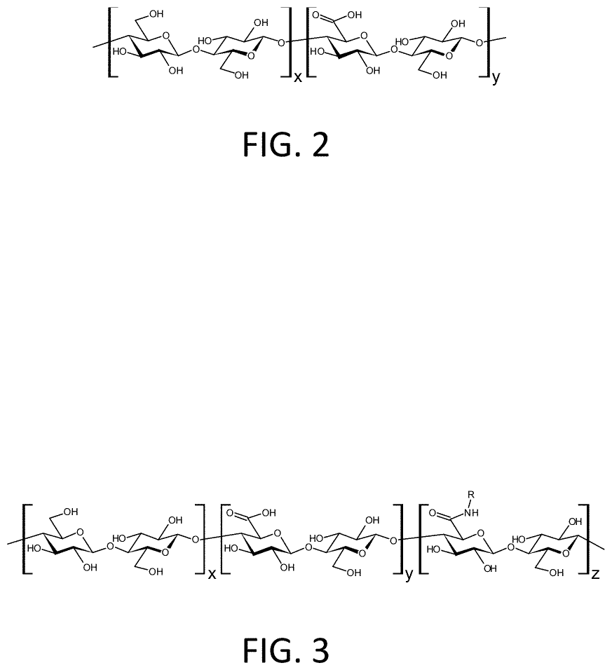

In one embodiment, the TEMPO-oxidized cellulose fiber has a chemical structure shown in FIG. 2 and consists of cellobiose units and oxidized cellobiose units with carboxyl groups, wherein the x of the cellobiose units is in a range of 0.5 to 0.83, the y of the oxidized cellobiose units with carboxyl groups is in a range of 0.17 to 0.5, and the sum of x and y is 1. The x and y are molar fractions of the cellobiose units and the oxidized cellobiose units with carboxyl groups, respectively, and are arbitrary values satisfying the condition of x+y=1. Moreover, the molality of the carboxyl groups is between 0.5 to 1.5 mmol/g, wherein if the molality of the carboxyl groups is less than 0.5 mmol/g, cellulose nanofiber is not obtained, and if the molality of the carboxyl groups is greater than 1.5 mmol/g, the cellulose nanofiber becomes weak and has lower effect. The molality of the carboxyl groups is preferably to be 1.0 to 1.2 mmol/g, and more preferably to be 1.2 to 1.5 mmol/g.

The oxidized cellulose nanofiber undergoes nano-fibrillization in step S105 to improve the quality of the oxidized cellulose nanofiber. It is to be noted that the oxidized cellulose nanofiber can be used with or without nano-fibrillization for further reactions, in other words, step S105 is optional. The nano-fibrillization is advantageous for the homogeneous reaction later, but requires longer time for purification. In one embodiment, the nano-fibrillization of the oxidized cellulose nanofiber includes washing or reducing with sodium borohydride (NaBH₄) to form reduced TEMPO-oxidized cellulose nanofiber. The reduction is to remove aldehyde groups which can cause colorization and smell.

Then, the reduced-TEMPO-oxidized cellulose nanofiber, or the TEMPO-oxidized cellulose fiber if step S105 was omitted, is washed to form TEMPO-oxidized cellulose nanofiber amide (TOCNF amide). In specific, the TEMPO-oxidized cellulose nanofiber is dispersed in reaction medium in step S107, wherein the media is water or organic solvents/aprotic solvents, for example, N,N-dimethylformamide (DMF) or acetonitrile. A solvent mixture is thus formed.

Next, condensation reagents are dissolved into the solvent mixture in step S109, or the nanofiber dispersion, to activate the carboxyl groups (COOH) in the TEMPO-oxidized cellulose nanofiber. The condensation reagents are, for example, 1-ethyl-3-(3-dimethylaminopropyl) carbodiimide hydrochloride (EDC) and N-hydroxysuccinimide (NHS).

In step S111, amine compounds with long alkyl chains are added to the solvent mixture to achieve the amidation reaction with the binding ratio in the range of 0.2 to 0.9 per carboxyl groups in the oxidized cellular nanofiber. The amine compounds with long alkyl chains are selected from, for example, a group of dodecylamine, tetradecylamine, hexadecylamine, octadecylamine, and oleylamine, and have 12 to 18 carbon atoms (C12 to C18). The amine compounds with long alkyl chains and the oxidized cellular nanofiber are mixed in step S113. In particular, the solvent mixture, or the reaction dispersion, is stirred to homogeneously mix the oxidized cellulose nanofiber and the amine compounds. It is to be noted that when the oxidized cellulose nanofiber is dispersed in water, the amine compounds are not soluble, and thus the amount of amine compounds should be excess to control the binding ratio mentioned above. In one embodiment, ultrasonication is used to facilitate the dispersing amine compound and to make the modified cellulose nanofibers.

More specifically, the TEMPO-oxidized cellulose nanofiber is surface modified by the amidation reaction, wherein the carboxyl groups (COOH) of the TEMPO-oxidized cellulose nanofiber react with the amine compounds with long alkyl chains to form alkylamine groups on the surface of the TEMPO-oxidized cellulose nanofiber, and hence the modified cellulose nanofibers are formed.

After the amidation reaction, which typically takes 1 to 2 hours, the modified cellulose nanofiber as the reaction product is recovered by filtration or centrifugation in step S115. In some embodiments, the reaction product is further washed by proper media for purification purpose, and if required, nano-fibrillization can be accomplished after the purification.

In step S117, the modified cellulose nanofiber is dried to form films or laminates. The thickness of the film can be controlled by this drying process. It is to be noted that the present disclosure does not limit the methods to dry the films, but overheating will lead to decomposition and deterioration of the films. In one embodiment, the film is dried by heating process at around 150 degree Celsius and with a maximum heating temperature of around 200 degree Celsius. In some embodiments, the modified cellulose nanofiber is used to make coating layers, and thus an article or a substrate is sprayed by, brushed with, or dipped in the modified cellulose nanofiber before drying to form the coating on the article/substrate.

The method of manufacturing modified cellulose nanofiber is generally performed in room temperature, and only when the drying method is a heating process or alike that the operation temperature is different.

In addition, the method is substantially free of fluorinated compound, where the material used in the process such as the reagents, the solvents, the compounds and the cellular nanofiber are non-fluorinated compounds.

FIG. 3 illustrates the chemical structure of a modified cellulose nanofiber according to an embodiment of the present disclosure. The modified cellulose nanofiber includes the chemical structure shown in FIG. 3, which includes cellobiose units, oxidized cellobiose units with carboxyl groups, and amide-cellobiose units, wherein molar fractions (x, y, z) thereof have the following ranges: the x of the cellobiose units is in a range of 0.5 to 0.83, the sum of y and z is in a range of 0.17 to 0.5, the z of the amide-cellobiose units is 20 to 90% of y+z of the carboxyl groups, and the sum of x, y and z is 1. The R in the chemical structure represents an alkyl group. The x, y and z are arbitrary values satisfying the condition of x+y+z=1. The amid-cellobiose units are oxidized and modified cellobiose units, which were oxidized with carboxyl groups and modified with alkylamine groups. In one embodiment, the molality of alkylamine groups is 0.1 to 1.0 mmol/g in the modified cellulose nanofiber and the alkylamine groups is 20 to 90% of the carboxyl groups (COOH) in TEMPO-oxidized cellulose nanofiber. In other words, the modified cellulose nanofiber is a TEMPO-oxidized cellulose nanofiber amidated with amine compounds with long alkyl chains and has alkylamine groups and carboxyl groups, wherein the alkylamine groups is introduced to 20 to 90% of the carboxyl groups, and preferably to be 30 to 70% of the carboxyl groups. The alkylamine groups or the long alkyl chains are, for example, octadecyl, oleyl, dodecyl and etc.

The modified cellulose nanofiber is composed of cellulose nanofiber, carboxyl groups and alkylamine groups, and no fluoride composition. Hence, the modified cellulose nanofiber is free of fluorinated compound.

The modified cellulose nanofiber can be used to form a single-layer laminate, wherein the laminate is made of the modified cellulose nanofiber that is a TEMPO-oxidized cellulose nanofiber amidated with amine compounds with long alkyl chains and has alkylamine groups and carboxyl groups, wherein the alkylamine groups is 20 to 90% of the carboxyl groups, and the laminate exhibits hydrophobicity and oil-repellency characteristics.

The laminate has a chemical structure shown in FIG. 3, wherein R represents an alkyl group, the x is in a range of 0.5 to 0.83, the sum of y and z is in a range of 0.17 to 0.5, the z is 20 to 90% of y+z, and the sum of x, y and z is 1. In one embodiment, the molality of alkylamine groups is 0.1 to 1.0 mmol/g in the laminate and the alkylamine groups is 20 to 90% of the carboxyl groups (COOH) in TEMPO-oxidized cellulose nanofiber.

The laminate is colorless and transparent and is mechanically strong to be a self-standing film. The self-standing film refers to a film product that is an article of its own for various applications, for example, but not limited to, a cover film placed in ice-cream product on top of the ice-cream to isolate the ice-cream from the paper lid, a cover film placed in cosmetic products at the opening of the container to isolate the cream from the plastic lid, and a protective film disposed on the surface of the electronic device to protect the screen from scratches and liquids. In some embodiments, the laminate is tinted with food coloring or other coloring ingredients to add color thereto while maintaining its transparency for other applications.

In one embodiment, the laminate is transparent and is a coating formed by spraying the modified cellulose nanofiber on an article, but the present disclosure is not limited thereby. Furthermore, since the only composition in the laminate is the modified cellulose nanofiber, the laminate is free of fluorinated compound and has a single layer structure.

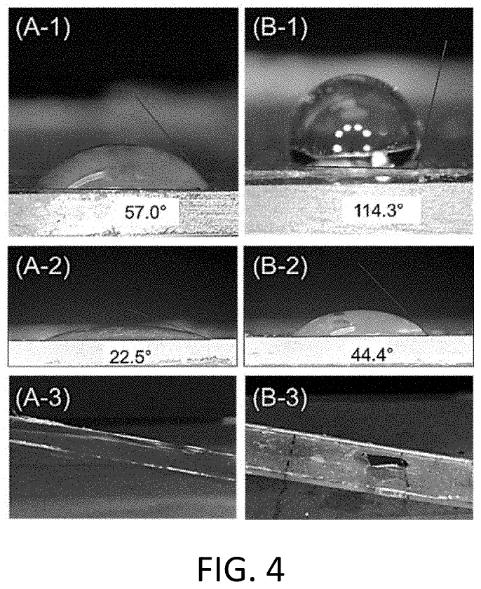

The hydrophobicity and oil-repellency of the laminate are confirmed by the contact angles and slipping behavior of oil drops at a tilt angle of 10 degrees as shown in FIG. 4. The photo images of (A) are tests performed on a conventional TEMPO-oxidized cellulose nanofiber film, hereinafter referred to as the conventional film, and the photo images of (B) are tests performed on a laminate film of the present disclosure, hereinafter referred to as the laminate film. First refer to images (A-1) and (B-1), where the water angle of the oil drop is measured, the water angle of the conventional film is 57.0 degrees, which is far smaller than water angle of the laminate film measured at 114.3 degrees.

Referring to images (A-2) and (B-2), where the oleic acid contact angle is measured, the oleic acid contact angle of the conventional film is 22.5 degrees and the oleic acid contact angle of the laminate film is 44.4 degrees. The laminate film again has a larger oleic acid contact angle.

As for the slipping test of hexadecane that is stained by 100 ppm of Sudan III, the image (A-3) shows the hexadecane splattered flat and flowed all over the conventional film, and the image (B-3) shows the hexadecane only splattered on a small area and the flow is thus restrained.

It can also be seen clearly that the oil drop on the laminate film maintains its droplet shape whereas the oil drop on the conventional film sags to the surface, and therefore the laminate film is more superior in hydrophobicity and oil-repellency than the conventional film.

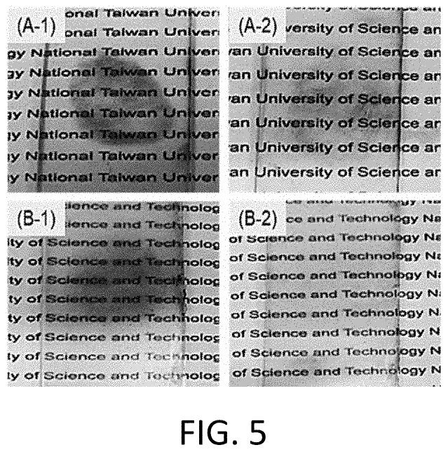

Furthermore, the anti-fingerprint property of the laminate is confirmed by the powder test as shown in FIG. 5. The photo images of (A) are tests performed on a conventional glass plate, hereinafter referred to as the conventional glass plate, and the photo images of (B) are tests performed on a glass plate coated with the laminate film of the present disclosure, hereinafter referred to as the laminated glass plate.

Referring to images (A-1) and (B-1), where ZnO powder on fingerprint is applied to the glass plate, the fingerprint on the conventional glass plate is more visible than the fingerprint on the laminated glass plate. Images (A-2) and (B-2) show the condition of the fingerprint on the glass plate after brushing. The fingerprint on the conventional glass plate is still quite visible after brushing but the fingerprint on the laminated glass plate is almost invisible to a point of clean glass plate. It is thus evident that the laminate of the present disclosure has an excellent anti-fingerprint property.

It is to be noted that the contrasts of the photo images are equally enhanced.

In view of above, the technical benefits of the modified cellulose nanofiber, the single-layer laminate including the same, and the method for manufacturing modified cellulose nanofiber as described by the embodiments of the present disclosure, in comparison to the conventional technology, are described below.

In conventional technology, the conventional films use perfluorinated compounds to accomplish oil-repellent and anti-fingerprint purposes, but the perfluorinated compounds are expansive and hazardous to the environment. Moreover, the conventional film is generally a thin coating layer applied on the other materials due to the cost and thus cannot be used by itself to accomplish the purposes. In contrast, the modified cellulose nanofiber of the present disclosure uses non-fluorides and nanofiber modified by long alkyl chains to obtain hydrophobicity and oil-repellency properties at low cost and is environmental friendly. Furthermore, the nanofiber provides sufficient mechanical property to make the single-layer laminate into a self-standing film all by itself without having to combine with other materials.

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

1. A modified cellulose nanofiber, comprising:
a TEMPO-oxidized cellulose nanofiber amidated with amine compounds with long alkyl chains and comprising alkylamine groups and carboxyl groups, wherein the alkylamine groups is 20 to 90% of the carboxyl groups.

2. The modified cellulose nanofiber according to claim 1, further comprising following chemical structure: 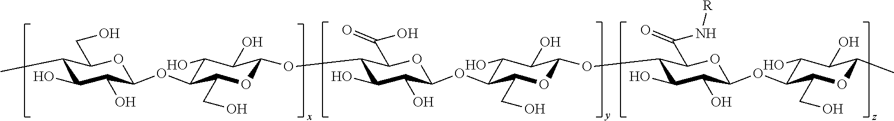
wherein x=0.5 to 0.83, y+z=0.17 to 0.5, z=0.2 to 0.9 of y+z, and x+y+z=1; and
wherein R represents an alkyl group.

3. The modified cellulose nanofiber according to claim 2, wherein a molality of the alkylamine groups is 0.1 to 1.0 mmol/g.

4. The modified cellulose nanofiber according to claim 1, wherein the alkylamine groups is preferably 30 to 70% of the carboxyl groups.

5. The modified cellulose nanofiber according to claim 1, wherein the alkylamine groups is dodecylamine, tetradecylamine, hexadecylamine, octadecylamine or oleylamine and comprises 12 to 18 carbon atoms.

6. The modified cellulose nanofiber according to claim 1, wherein the modified cellulose nanofiber is free of fluorinated compound.

7. A single-layer laminate comprising the modified cellulose nanofiber as defined in claim 1, wherein the laminate exhibits hydrophobicity and oil-repellency characteristics.

8. The single-layer laminate according to claim 7, where in the single-layer laminate is transparent.

9. The single-layer laminate according to claim 7, wherein the single-layer laminate is a coating formed by spraying the modified cellulose nanofiber on an article.

10. The single-layer laminate according to claim 7, wherein the single-layer laminate is a self-standing film.

11. The single-layer laminate according to claim 10, wherein a thickness of the self-standing film is equal to or greater than 10 μm.

12. The single-layer laminate according to claim 7, wherein the single-layer laminate is free of fluorinated compound.

13. A method for manufacturing modified cellulose nanofibers, comprising:
providing cellulose;
oxidizing the cellulose by TEMPO-oxidation reaction;
dispersing the oxidized cellulose in a solvent to form a solvent mixture, wherein the solvent is water or organic solvent; and
adding amine compounds with long alkyl chains to the solvent mixture and mixing the amine compounds and the oxidized cellulose homogeneously to achieve amidation reaction with a binding ratio of 20 to 90% carboxyl groups in the modified cellulose nanofiber.

14. The method for manufacturing modified cellulose nanofiber according to claim 13, further comprising recovering the modified cellulose nanofiber by filtration or centrifugation.

15. The method for manufacturing modified cellulose nanofiber according to claim 13, further comprising drying the modified cellulose nanofiber to form a laminate film.

16. The method for manufacturing modified cellulose nanofiber according to claim 13, further comprising performing nano-fibrillization to the oxidized cellulose.

17. The method for manufacturing modified cellulose nanofiber according to claim 13, further comprising dissolving a condensation reagent in the solvent mixture to activate the carboxyl groups in the oxidized cellulose.

18. The method for manufacturing modified cellulose nanofiber according to claim 13, wherein the amine compounds with long alkyl chains are dodeylamine, tetradecylamine, hexadecylamine, octadecylamine or oleylamine and comprise 12 to 18 carbon atoms.

19. The method for manufacturing modified cellulose nanofiber according to claim 13, wherein the method is substantially free of fluorinate compound.

20. The method of manufacturing modified cellulose nanofiber according to claim 13, wherein a molality of the carboxyl groups in the oxidized cellulose before amidation is 0.5 to 1.5 mmol/g
